(19) United States
(12) Patent Application Publication
(10) Pub. No.: US 2021/0174975 A1
(43) Pub. Date: Jun. 10, 2021

(54) CAR TO HOME SERVICE SYSTEM AND METHOD

(71) Applicants: HYUNDAI MOTOR COMPANY, Seoul (KR); KIA MOTORS CORPORATION, Seoul (KR)

(72) Inventor: Yong Woo Shin, Hwaseong-si (KR)

(21) Appl. No.: 16/801,495

(22) Filed: Feb. 26, 2020

(30) Foreign Application Priority Data
Dec. 6, 2019 (KR) 10-2019-0161988

(51) Int. Cl. G16Y 40/35; G16Y 40/10; H04W 84/18; H04W 4/44

(52) U.S. Cl. CPC G16Y 40/35; H04W 4/44; H04W 84/18; G16Y 40/10

(57) ABSTRACT

Disclosed is a car to home service system and a method of setting service time-out thereof for dynamically setting service time-out based on types of devices and the number of the devices with respect to an Internet of things (IoT) device to be remotely controlled in a vehicle and providing a car to home service based on the set service time-out.

### CROSS REFERENCE TO RELATED APPLICATIONS

This application claims the priority benefit of Korean Patent Application No. 10-2019-0161988, filed on Dec. 6, 2019 in the Korean Intellectual Property Office, the disclosure of which is incorporated herein by reference.

### BACKGROUND

### 1. Field

The present disclosure relates to a car to home service system and method.

### 2. Description of the Related Art

A car to home service is a connected car service for remotely controlling a home Internet of things (IoT) device positioned in a home, for example, an illumination device, an air conditioner, a washing machine, a drier, a refrigerator, and a gas circuit breaker, within a vehicle. A vehicle original equipment manufacturer (OEM) for providing the connected car service sets and manages time-out in order to prevent deadlock of a head unit (H/U) in the vehicle. Time-out is obtained by subtracting a sending time of sending a command by a head unit (H/U) of a vehicle from a receiving time of receiving a result from a vehicle OEM and is commonly applied to most connected car services.

Conventional time-out of a connected car service is designed based on a self-serving service (vehicle remote control and vehicle remote state check) of the vehicle OEM, and thus, is defined as a constant value. Like in a car to home service, when there are numerous service participants and an entire configured layer has multiple levels, it is not possible to represent service complexity by the conventional time-out having a constant value, and thus there is a limit in that it is not possible to provide a service despite of an actual normal operation. For example, referring to FIG. 1, like in Case 1, when total time consumption (entire operation time) Tₜₒₜₐₗ for controlling a lamp, a plug, and a boiler is equal to or greater than service time-out Tₜᵢₘₑ₋ₒᵤₜ, the current state is always determined as ‘service failure’ irrespective of whether a corresponding service is successful or fails. Like in Case 2, when an average operation time Tₜₒₜₐₗ (Avg.) is equal to or greater than the service time-out Tₜᵢₘₑ₋ₒᵤₜ, the current state is determined as service failure in most cases. In addition, like in Case 3, when the entire operation time Tₜₒₜₐₗ is less than the service time-out Tₜᵢₘₑ₋ₒᵤₜ, a head unit (H/U) of a vehicle is not actually capable of receiving return from a server due to service failure, but the service time-out Tₜᵢₘₑ₋ₒᵤₜ remains and thus the head unit (H/U) of the vehicle needs to be on standby (deadlock).

### SUMMARY

Therefore, the present disclosure has been made in view of the above problems, and it is an object of the present disclosure to provide a car to home service system and method for dynamically setting service time-out depending on a service environment.

In accordance with an aspect of the present disclosure, the above and other objects can be accomplished by the provision of a car to home service system including a service server configured to dynamically set service time-out based on types of devices and the number of the devices with respect to an Internet of things (IoT) device to be remotely controlled in a vehicle and to provide a car to home service based on the set service time-out.

The service server may include a database configured to store and manage an interface device list, a search and control execution list, information on time consumption for each search and control case, and information on time-out setting.

The service server may combine the types of the devices depending on the number of the devices and classifies a control group using the interface device list.

The service server may calculate total time consumption for search and control execution for each control group using the search and control execution list and the information on the time consumption for each search and control case and may calculate an average and a variance of time consumption for an operation for each control group through normal distribution fitting on the total time consumption for search and control execution for each control group.

The service server may detect and remove a failure case of the search and control execution list and data with time consumption greater than threshold time consumption, as an outlier.

The service server may set a time-out rule based on the average and the variance of the time consumption for the operation for each control group.

The time-out rule may be a reference variance for determining a range for determining a normal operation of the number of occurrences.

The service server may sets time-out for each control group based on the time-out rule.

The service server may set time-out using the total time consumption for search and control execution to be matched with the reference variance.

The service server may associate a vehicle user account and an IoT service account with each other and may manage the vehicle user account and the IoT service account.

In accordance with another aspect of the present disclosure, the above and other objects can be accomplished by the provision of a car to home service method including detecting types of devices and the number of the devices with respect to an Internet of things (IoT) device to be remotely controlled in a vehicle, dynamically setting service time-out based on the types of the devices and the number of the devices, and providing a car to home service based on setting of the service time-out.

The dynamically setting the service time-out may include calculating an average and a variance of time consumption for an operation for each control group based on the types of the devices and the number of the devices, and setting time-out for each control group by analyzing the average and the variance of the time consumption for the operation.

The calculating the average and the variance of the time consumption for the operation for each control group may include combining the types of the devices depending on the number of the devices and classifying a control group using an interface device list pre-stored in a database, calculating total time consumption for search and control execution for each control group using a search and control execution list and information on time consumption for each search and control case, pre-stored in the database, calculating the average and the variance through normal distribution fitting on the total time consumption for search and control execution for each control group, and setting a time-out rule based on the average and the variance of the time consumption for the operation for each control group.

The calculating the total time consumption for search and control execution for each control group may further include detecting and removing a failure case of the search and control execution list and data with time consumption greater than threshold time consumption, as an outlier.

The setting the time-out for each control group may include setting the time-out for each control based on the time-out rule.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a diagram for explaining a problem of a conventional art;

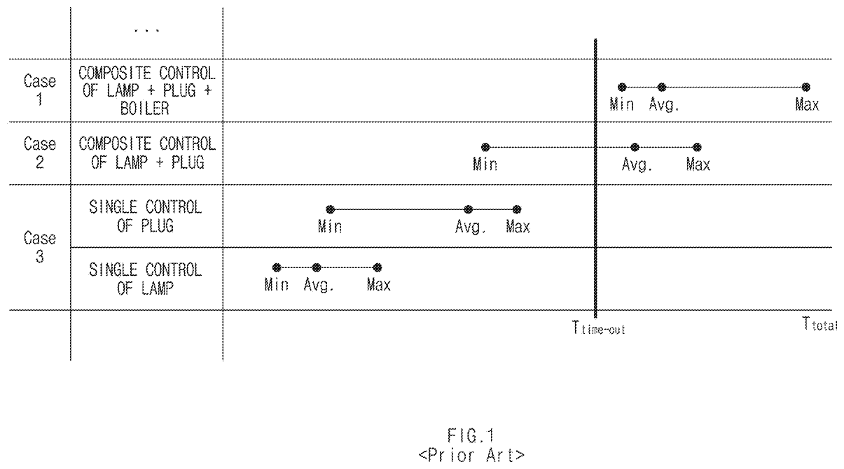

FIG. 2 is a diagram illustrating the configuration of a car to home service system according to an embodiment of the present disclosure;

FIG. 3 is a block diagram of a service server illustrated in FIG. 2;

FIG. 4 is a diagram for explanation of dynamic setting of time-out for each group according to an embodiment of the present disclosure;

FIG. 5 is a diagram for explanation of derivation of time-out for each group related to the present disclosure;

FIG. 6 is a diagram for explanation of a result of dynamic setting of time-out related to the present disclosure;

FIG. 7 is a flowchart illustrating a car to home service method related to the present disclosure; and

FIG. 8 is a flowchart illustrating a procedure of calculating an average and a variance of time consumption for an operation for each control combination of an IoT device illustrated in FIG. 7.

### DETAILED DESCRIPTION

Hereinafter, at least one embodiment of the present disclosure will be described in detail with reference to the accompanying drawings. In the following description, like reference numerals designate like elements although the elements are shown in different drawings. Further, in the following description of the at least one embodiment, a detailed description of known functions and configurations incorporated herein will be omitted for the purpose of clarity and for brevity.

Additionally, in describing the components of the present disclosure, terms like first, second, A, B, (a), and (b) are used. These are solely for the purpose of differentiating one component from another, and one of ordinary skill would understand the terms are not to imply or suggest the substances, order or sequence of the components. Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

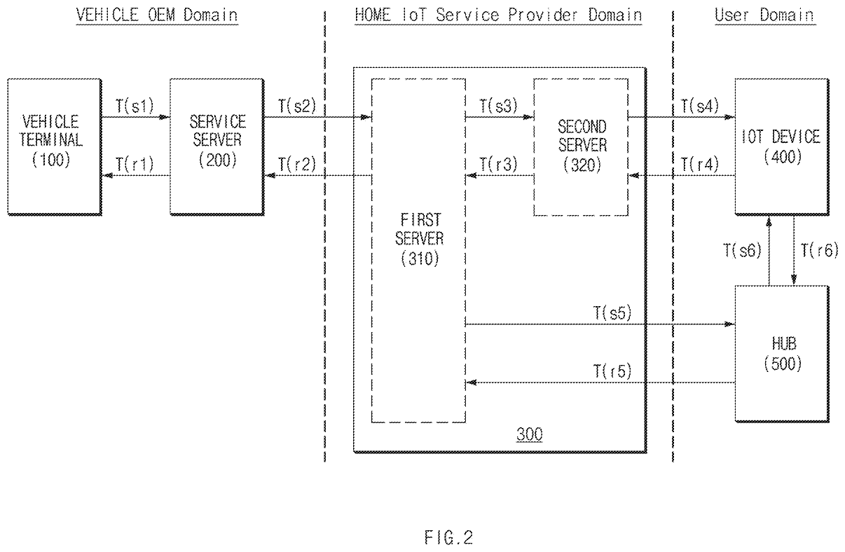

FIG. 2 is a diagram illustrating the configuration of a car to home service system according to an embodiment of the present disclosure.

Referring to FIG. 2, the car to home service system may include a vehicle terminal 100, a service server 200, an Internet of things (IoT) server 300, an IoT device 400, and a hub 500.

The vehicle terminal 100 may be an electronic device installed in a vehicle and may be embodied as a head unit (H/U). Although not illustrated in the drawing, the vehicle terminal 100 may include a communication device, an input device, an output device, a processor, a memory, and the like.

The vehicle terminal 100 may transmit a car to home command (e.g., search or operation control) input by a user to the service server 200. The vehicle terminal 100 may receive a processing result of the car to home command from the service server 200 and may output the processing result through a display and/or a speaker.

The service server 200 may be an original equipment manufacturer (OEM) server for providing a car to home service, may receive the car to home command generated in the vehicle, and may transfer the car to home command to the IoT server 300. When receiving the car to home command transmitted from the vehicle terminal 100, the service server 200 may transmit the received car to home command to the IoT server 300. The service server 200 may receive a processing result of the car to home command from the IoT server 300 and may transmit (transfer) the processing result to the vehicle terminal 100.

The service server 200 may dynamically set service time-out depending on a service environment. The service server 200 may manage a vehicle user account and an IoT service account.

The IoT server 300 may provide an IoT service and may include a first server 310 and a second server 320. According to the present embodiment, an example in which the IoT server 300 includes the first server 310 and the second server 320 is described, but the IoT server 300 may include the first server 310 alone.

The first server 310 may be a contents provider (CP) server for performing an IoT service and may transfer information on a registered IoT device to the service server 200. The first server 310 may issue a command to the IoT device 400 interfaced therewith in response to a request of each vehicle, received from the service server 200, and may transfer a result with respect to the command to the service server 200.

The service server 200 and the first server 310 may recognize the vehicle user account (i.e., a car to home service user account) and the IoT service account as one user through matching therebetween.

The second server 320 may be a server of an IoT device manufacturer, may acquire state information of the IoT device 400, and may transmit (provide) the state information to the first server 310. In addition, the second server 320 may control an operation of the IoT device 400 depending on a request of the first server 310, may acquire state information of the IoT device 400, which is changed by the control, and may transfer the state information to the first server 310.

Thus far, although the case in which the first server 310 acquires the state information of the IoT device 400 through the second server 320 and controls an operation of the IoT device 400 is described, the present disclosure is not limited thereto, and thus the first server 310 may be directly connected to the IoT device 400 to acquire the state information of the IoT device 400 and to control an operation thereof.

The IoT device 400 may a home smart device installed in a home and may communicate with the IoT server 300. The IoT device 400 may be an illumination device, a smart plug, an air conditioner, a washing machine, a drier, a refrigerator, a boiler, and/or a gas circuit breaker.

The hub 500 may be installed in a home and may support communication of the first server 310 with the IoT device 400 in a home.

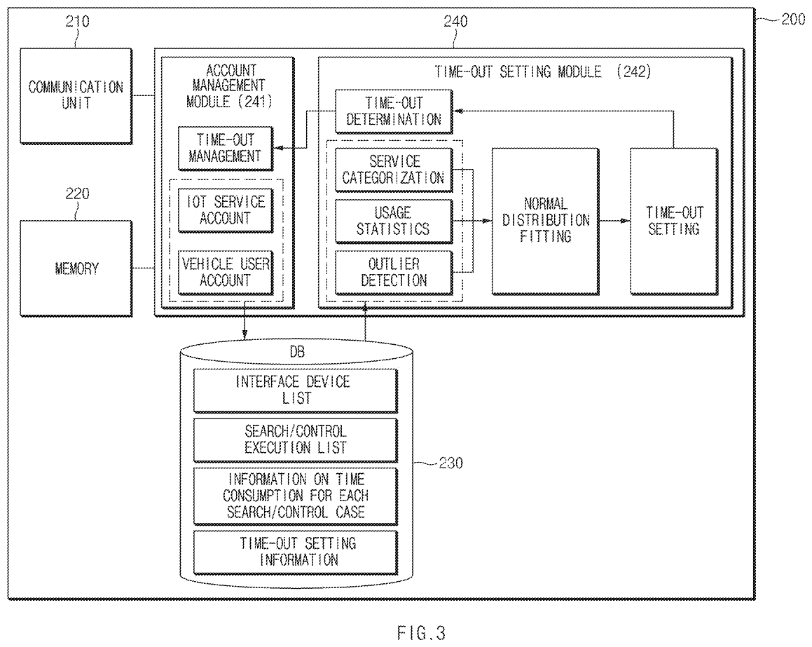

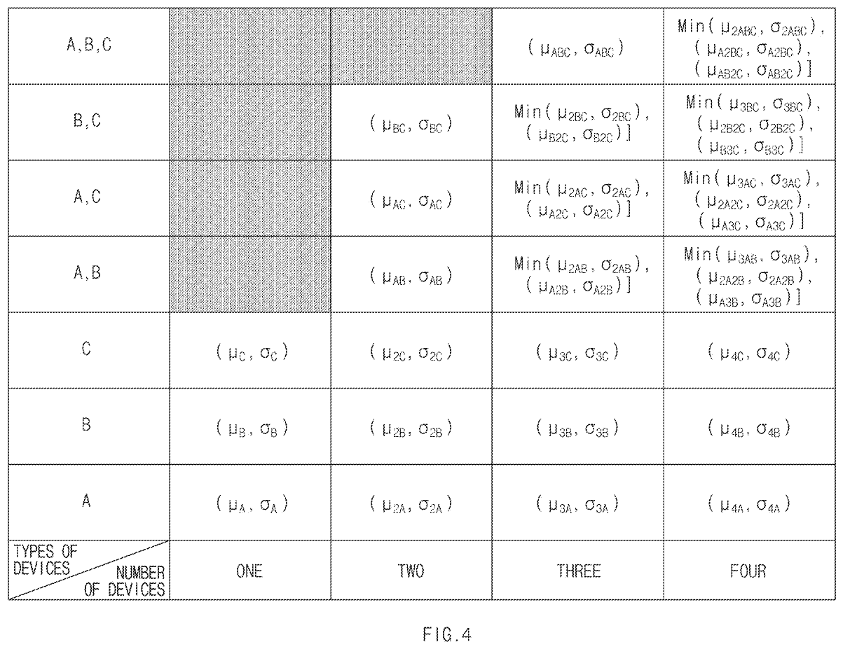

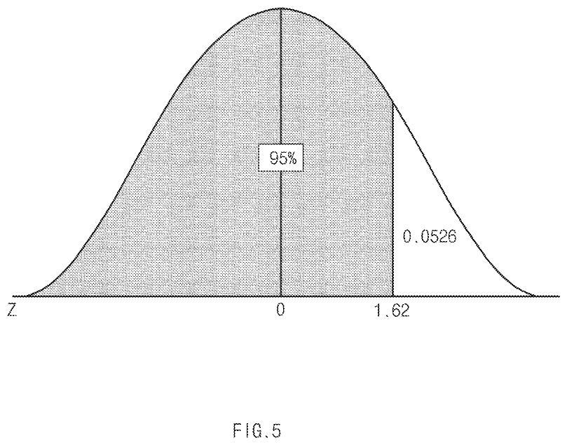

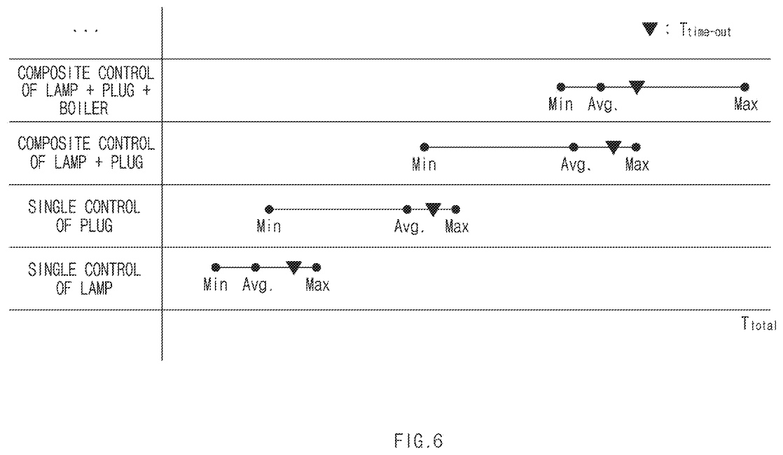

FIG. 3 is a block diagram of the service server illustrated in FIG. 2. FIG. 4 is a diagram for explanation of dynamic setting of time-out for each group according to an embodiment of the present disclosure. FIG. 5 is a diagram for explanation of derivation of time-out for each group related to the present disclosure. FIG. 6 is a diagram for explanation of a result of dynamic setting of time-out related to the present disclosure.

Referring to FIG. 3, the service server 200 may include a communication unit 210, a memory 220, a database (DB) 230, and a processor 240.

The communication unit 210 may communicate with the vehicle terminal 100 and/or the IoT server 300 through a communication network. The communication network may be embodied as vehicle to infrastructure (V2I), wireless LAN (WLAN), Wi-Fi, code division multiple access (CDMA), global system for mobile communication (GSM), long term evolution (LTE), international mobile telecommunication (IMT)-2020, a local area network (LAN), a Wide area network (WAN), the Ethernet, and/or an integrated services digital network (ISDN).

The memory 220 may store software programmed to enable the processor 240 to perform a predetermined operation. The memory 220 may temporally store input data and/or output data of the processor 240. The memory 220 may be embodied as at least one of storage media (recording media) such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), and/or a register.

The DB 230 may store and manage car to home service usage information for each vehicle user account, i.e., an interface device list, a search and control execution list, information on time consumption for each search and control case, and information on time-out setting. The interface device list may be a list of home smart devices to be controlled through a car to home service for each IoT service account. The interface device list may store one actual device name for each category item. For example, the interface device list may include room 1 and lamp 1, room 1 and lamp 2, room 2 and lamp 1, room 2 and lamp 2, an air conditioner of a main room, air conditioner 1 of a living room, air conditioner 2 of the living room, and the like. The search and control execution list (search/control execution list) may include a history (e.g., target temperature 29 degrees and/or On/Off) of search or dynamic control of the current state (e.g., On/Off and/or setting temperature) of the IoT device 400 in the vehicle. The information on time consumption for each search and control case (time consumption for each search/control case) may include a time (a time to perform an operation) taken to execute the command by the vehicle terminal 100 and to output a result thereof to the vehicle terminal 100 when each operation is executed in the search/control execution list. The time-out setting information may include a search/control time-out setting value of all the IoT devices 400 registered in the interface device list.

The processor 240 may control an overall operation of the service server 200. The processor 240 may be embodied as at least one of an application specific integrated circuit (ASIC), a digital signal processor (DSP), a programmable logic device (PLD), field programmable gate arrays (FPGAs), a central processing unit (CPU), microcontrollers, and/or microprocessors.

The processor 240 may include an account management module 241 and a time-out setting module 242. The account management module 241 may associate the vehicle user account and the IoT service account with each other and may manage the same. The vehicle user account may be a user account registered in the service server 200, and the IoT service account may be a user account registered in the IoT server 300. The account management module 241 may manage car to home time-out for each vehicle user account.

The time-out setting module 242 may analyze a service completion time according to the car to home service configuration (i.e., service environment). The time-out setting module 242 may determine time-out for each vehicle user account based on the analysis result. The time-out setting module 242 may perform service categorization, usage statistics, outlier detection, and time-out calculation.

In detail, the time-out setting module 242 may classify a service category (control group) according to types of devices and the number of the devices using the interface device list managed by the DB 230. The time-out setting module 242 may combine and group the IoT devices 400 depending on types of devices and the number of the devices with respect to an interfaced device, i.e., the IoT devices 400 to be controlled through a car to home service. For example, when a device type includes three types of A, B, and C, device types may be combined and a control group may be classified depending on the number of devices, as shown in FIG. 4.

The time-out setting module 242 may calculate total time consumption (service completion time) for search/control execution for each control group using the information on the search/control execution list and the time consumption for each search/control case stored in the DB 230. The time-out setting module 242 may calculate a sending time of sending a search/control request and a receiving time of receiving a result of the request in the vehicle terminal 100 for each search/control execution case with respect to the IoT device 400, the request being requested by the vehicle.

The time-out setting module 242 may detect a failure case of the search/control execution list and data with time consumption greater than threshold time consumption, as an outlier. The time-out setting module 242 may remove the detected outlier.

The time-out setting module 242 may derive (calculate) an average μ and a variance σ through normal distribution fitting on the data on the total time consumption for search/control execution for each control group.

The time-out setting module 242 may set a time-out rule based on the average and the variance that are derived through analysis of data of generating time consumption for an operation for each control group. Here, the time-out rule may refer to a range in which a time-out setting value (predetermined time consumption) is determined as a normal operation of the number of occurrences. In other words, the time-out rule may be a reference variance for determining a range for determining a normal operation of the number of occurrences.

The time-out setting module 242 may determine (calculate) time-out (i.e., elapsed time or delay time) for each group based on the set time-out rule. The time-out setting module 242 may set time-out using the total time consumption for search and control execution to be matched with the reference variance. For ex ample, as shown in FIG. 5, when a variance of 95% is set to the time-out rule, the time-out setting module 242 may derive time-out including a range of 95% according to an average and variance for each control group.

The time-out setting module 242 may transfer the determined time-out for each group to the account management module 241 and may set the service time-out. The account management module 241 may apply the time-out for each group to the vehicle user account information and may provide the car to home service based on the time-out setting that is applied when the car to home service is executed.

Thus, as shown in FIG. 6, time-out may be dynamically set depending on a car to home service environment, that is, lamp single control, plug single control, composite control of a lamp and a plug, and/or composite control of a lamp, a plug, and a boiler, thereby overcoming a conventional limitation of providing a service when time-out is set to a single constant value.

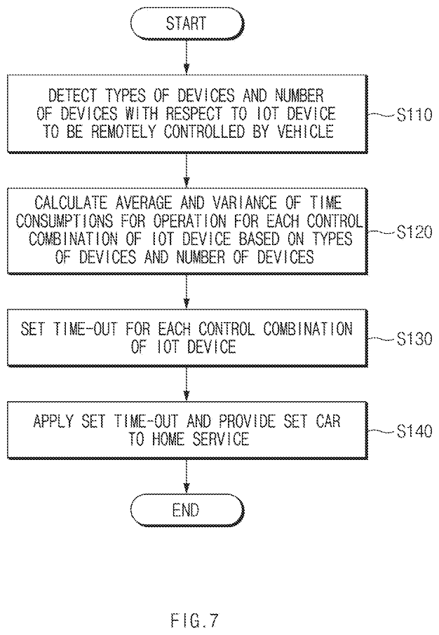

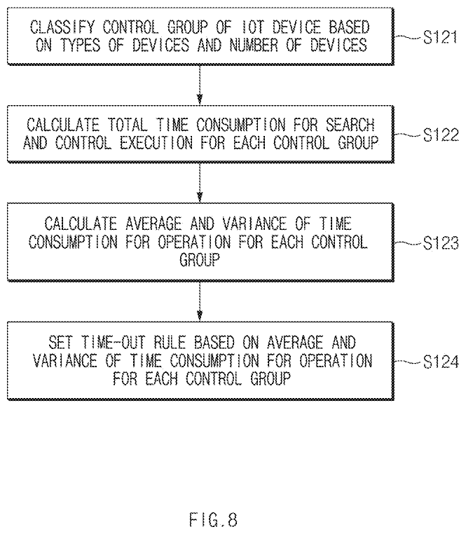

FIG. 7 is a flowchart illustrating a car to home service method related to the present disclosure. FIG. 8 is a flowchart illustrating a procedure of calculating an average and a variance of time consumption for an operation for each control combination of the IoT device illustrated in FIG. 7.

Referring to FIG. 7, the service server 200 may detect types of devices and the number of devices with respect to the IoT devices 400 to be remotely controlled by each vehicle (S110). The processor 240 of the service server 200 may check the types of devices and the number of devices with respect to the IoT device(s) 400, which is interfaced with the processor 240 to be controlled through a car to home service for each vehicle user account using the interface device list stored in the DB 230.

The service server 200 may calculate an average and a variance of time consumptions for an operation for each control combination of the IoT device 400 based on types of devices and the number of the devices (S120). In more detail, referring to FIG. 8, the service server 200 may classify a control group depending on the types of the devices and the number of the devices using the interface device list (S121). In other words, the service server 200 may combine the types of the devices depending on the number of the devices and may classify (distinguish) a control group. For example, when an interfaced device has two types of a lamp and an air conditioner and the number of the devices is two, the service server 200 may classify a control group (service category) into single control of one lamp, single control of one air conditioner, composite control of two lamps, composite control of two air conditioners, and composite control of one lamp and one air conditioner. The service server 200 may calculate total time consumption for search/control execution for each control group using the search/control execution list and the information on the time consumption for each search/control case stored in the DB 230 (S122). The service server 200 may derive a sending time of sending a search/control request and a receiving time of receiving a result of the request in the vehicle terminal 100 for each search/control execution case with respect to the IoT device 400, the request being requested by the vehicle. The service server 200 may detect and remove a failure case of the search/control execution list and data on excessive total time consumption of the search/control execution list, i.e., an outlier. The service server 200 may derive (calculate) an average μ and a variance σ through normal distribution fitting on the data on the total time consumption for search/control execution for each control group (S123). The service server 200 may set a time-out rule based on the average and the variance that are derived through analysis of data of generating time consumption for an operation for each control group (S124). Here, the time-out rule may be a reference variance for determining a range for determining a normal operation of the number of occurrences.

The service server 200 may set time-out for each control combination of the IoT device 400 (S130). The service server 200 may determine (calculate) time-out (i.e., elapsed time or delay time) for each group based on the set time-out rule. The service server 200 may set time-out using the total time consumption for search and control execution to be matched with the reference variance.

The service server 200 may apply the set time-out to a car to home service and may provide the car to home service (S140). The service server 200 may apply the determined time-out for each group and may set service time-out for each vehicle user account. Then, the service server 200 may provide the car to home service based on the applied time-out setting when the car to home service is used.

According to the present disclosure, service time-out may be dynamically set depending on a service environment, and thus a ratio in that a service is not capable of being provided due to the time-out even if it is possible to actually provide the service may be reduced, and unnecessary stand-by to time-out may not occur in an actual service failure case. While the present disclosure has been particularly shown and described with reference to exemplary embodiments thereof, it will be understood by those skilled in the art that various changes in form and details may be made therein without departing from the spirit and scope of the present disclosure as defined by the appended claims. Accordingly, the exemplary embodiments should be considered in descriptive sense only and not for purposes of limitation. The scope of the present disclosure is defined not by the detailed description of the present disclosure but by the appended claims, and all differences within the scope will be construed as being included in the present disclosure.

1. A car to home service system including a service server configured to dynamically set service time-out based on types of devices and the number of the devices with respect to an Internet of things (IoT) device to be remotely controlled in a vehicle and to provide a car to home service based on the set service time-out.

2. The car to home service system of claim 1, wherein the service server includes a database configured to store and manage an interface device list, a search and control execution list, information on time consumption for each search and control case, and information on time-out setting.

3. The car to home service system of claim 2, wherein the service server combines the types of the devices depending on the number of the devices and classifies a control group using the interface device list.

4. The car to home service system of claim 3, wherein the service server calculates total time consumption for search and control execution for each control group using the search and control execution list and the information on the time consumption for each search and control case and calculates an average and a variance of time consumption for an operation for each control group through normal distribution fitting on the total time consumption for search and control execution for each control group.

5. The car to home service system of claim 4, wherein the service server detects and removes a failure case of the search and control execution list and data with time consumption greater than threshold time consumption, as an outlier.

6. The car to home service system of claim 4, wherein the service server sets a time-out rule based on the average and the variance of the time consumption for the operation for each control group.

7. The car to home service system of claim 6, wherein the time-out rule is a reference variance for determining a range for determining a normal operation of the number of occurrences.

8. The car to home service system of claim 7, wherein the service server sets time-out for each control group based on the time-out rule.

9. The car to home service system of claim 8, wherein the service server sets time-out using the total time consumption for search and control execution to be matched with the reference variance.

10. The car to home service system of claim 1, wherein the service server associates a vehicle user account and an IoT service account with each other and manages the vehicle user account and the IoT service account.

11. A car to home service method comprising:
detecting types of devices and the number of the devices with respect to an Internet of things (IoT) device to be remotely controlled in a vehicle;
dynamically setting service time-out based on the types of the devices and the number of the devices; and
providing a car to home service based on setting of the service time-out.

12. The car to home service method of claim 11, wherein the dynamically setting the service time-out includes:
calculating an average and a variance of time consumption for an operation for each control group based on the types of the devices and the number of the devices; and
setting time-out for each control group by analyzing the average and the variance of the time consumption for the operation.

13. The car to home service method of claim 12, wherein the calculating the average and the variance of the time consumption for the operation for each control group includes:
combining the types of the devices depending on the number of the devices and classifying a control group using an interface device list pre-stored in a database;
calculating total time consumption for search and control execution for each control group using a search and control execution list and information on time consumption for each search and control case, pre-stored in the database;
calculating the average and the variance through normal distribution fitting on the total time consumption for search and control execution for each control group; and
setting a time-out rule based on the average and the variance of the time consumption for the operation for each control group.

14. The car to home service method of claim 13, wherein the calculating the total time consumption for search and control execution for each control group further includes detecting and removing a failure case of the search and control execution list and data with time consumption greater than threshold time consumption, as an outlier.

15. The car to home service method of claim 13, wherein the setting the time-out for each control group includes setting the time-out for each control based on the time-out rule.
